(19) United States
(12) Patent Application Publication
(10) Pub. No.: US 2010/0255905 A1
(43) Pub. Date: Oct. 7, 2010

(54) METHOD FOR CREATING GAME MAP

(75) Inventor: YE YUAN, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY(ShenZhen) CO., LTD., Shenzhen City (CN); HON HAI PRECISION INDUSTRY CO., LTD., Tu-Cheng (TW)

(21) Appl. No.: 12/485,297

(22) Filed: Jun. 16, 2009

(30) Foreign Application Priority Data
Apr. 1, 2009 (CN) 200910301279.6

(51) Int. Cl. A63F 13/00

(52) U.S. Cl. 463/31

(57) ABSTRACT

A method for creating game map includes the following steps. An area of a real world map is selected. A layout of the game map is established based on the selected area. An event generation area is defined on the layout of the game map at a position corresponding to an item image on the real world map. An item-triggered event is added to the event generation area associated with a real world attribute of the item image. The layout of the game map is exported and stored to a computer storage.

### BACKGROUND

1. Technical Field

The invention generally relates to a method for creating computer game maps for single or multiplayer games.

2. Description of Related Art

In computer games, game maps are usually created by some game map creating tools based on a story or a campaign. With some games, the computer may generate random game maps, usually in real-time strategy games. For example, the computer game may include a plurality of historically-based campaigns, which can constrict the player to specialized and story-backed conditions. However, the game maps in computer games are limited, and the limited game maps may reduce the attraction of the game.

### BRIEF DESCRIPTION OF THE DRAWINGS

FIG. 1 is a block view of an input and output connection of a game engine.

FIG. 2 is a flowchart of a method for creating a game map.

### DETAILED DESCRIPTION

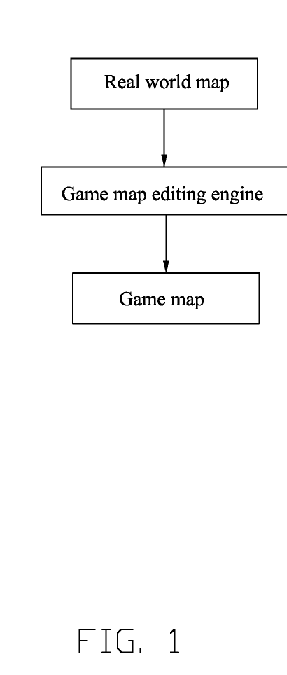

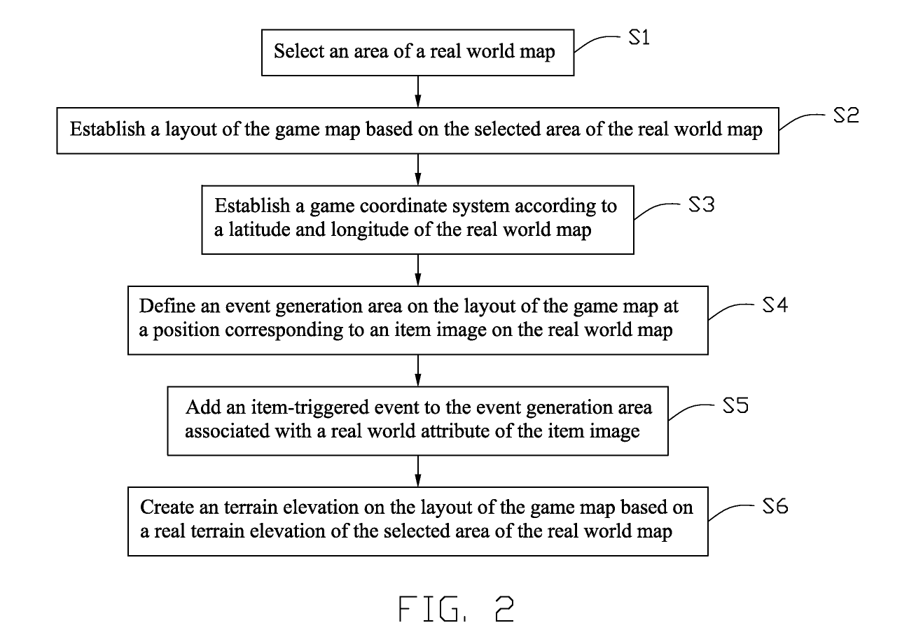

Referring to FIG. 1 and FIG. 2, in present embodiment, a game map editing engine is capable of creating a game map based on a real world map. A method for creating a game map includes the following steps.

In a step S1, an area of a real world map is selected. The real world map can be acquired from a map provider. The real world map may be updated at intervals by the map provider, so that the game map is capable of being updated according to changes to the real world map. The selected area of the real world map may be an area at an actual location of a player. The actually location can be acquired through a global positioning system (GPS) system.

In a step S2, a layout of the game map is established based on the selected area. The layout of the game map is scaled down from the selected area of the real world map.

In a step S3, a game coordinate system is established according to a latitude and longitude of the real world map.

In a step S4, an event generation area is defined on the layout of the game map at a position corresponding to an item image on the real world map. The item image is one or a group of trees, roads, mountains, buildings, water and some other feature item images in the real world map. For example, when the item image is a road, the event generation area is a game pathway for a player follow.

In a step S5, an item-triggered event is added to the event generation area associated with a real world attribute of the item image. For example, an item image in the real world map corresponds to a gas station. The gas station provides oil service to cars in actual world. An event generation area of the item image succeeds the attributing of the gas station to provide oil service to cars in a race game. When a player drives a car into the event generation area in the race game, an oil service event is triggered. In some other examples, an item image of a department store, a hotel, etc may also be defined.

In a step S6, terrain elevation is created on the layout of the game map based on real terrain elevation of the selected area of the real world map. The layout of the game map may be exported or stored to a computer storage.

The layout of the game map is capable of being converted to and exported in a special or user-defined file format to a computer or an electronic device. When the game map is ready, some graphic effect may be rendered on the game map.

The game map may be used in a race game. For example, the game map may come from a real area familiar to a player. A racing path may duplicate a road the player just drove an hour before. The environment items beside the raceway can duplicate actual conditions of areas have actually visited. Many other kinds of games can benefit from this kind of game mapping.

It is also to be understood that the above description and the claims drawn to a method may include some indication in reference to certain steps. However, the indication used is only to be viewed for identification purposes and not as a suggestion as to an order for the steps.

What is claimed is:

1. A computer-implemented method for creating game map comprising:
selecting an area of a real world map;
establishing a layout of the game map based on the selected area;
defining an event generation area on the layout of the game map at a position corresponding to an item image on the real world map;
adding an item-triggered event to the event generation area associated with a real world attribute of the item image; and
exporting and storing the layout of the game map to a computer storage.

2. The method of the claim 1, wherein the selected area of the real world map is an area at an actual location of a player, and the actually location is acquired through a global positioning system.

3. The method of the claim 1, wherein the item image is one group of trees, roads, mountains, buildings and water.

4. The method of the claim 1 further comprising creating a terrain elevation on the layout of the game map based on a real terrain elevation of the selected area of the real world map.

5. The method of the claim 1, wherein the layout of the game map is scaled down from the selected area of the real world map.

6. The method of the claim 1, wherein the layout of the game map is converted to and exported in a defined file format.

7. The method of the claim 1, wherein a game coordinate system is established according to a latitude and longitude of the real world map.

8. The method of the claim 1, wherein the item image is a road, and the game item is a game pathway for a player to follow.

9. The method of the claim 1, wherein the layout of the game map is capable of being updated according to changes to the real world map.
